(19) United States
(12) Patent Application Publication
(10) Pub. No.: US 2004/0074119 A1
(43) Pub. Date: Apr. 22, 2004

(54) Method and system for organizing samples

(76) Inventor: Hyesook Kim, Bloomfield, MI (US)

Correspondence Address: Amy E. Rinaldo, Kohn & Associates, PLLC, Suite 410, 30500 Northwestern Highway, Farmington Hills, MI, 48334, US

(21) Appl. No.: 10/686,997

(22) Filed: Oct. 16, 2003

Related U.S. Application Data
(60) Provisional application No. 60/419,165, filed on Oct. 16, 2002.

(51) Int. Cl. G09F 3/00

(52) U.S. Cl. 40/312

(57) ABSTRACT

An organizational system marked grid including specific locations and a spreadsheet including designations relating to the locations on the marked grid, such that each of the designations includes details regarding items located in each of the locations. A method of organizing items by placing items in a marked grid and cataloging the location of the items in a corresponding spreadsheet is also provided. A method to organize goods in a container having a grid marked on a bottom portion of the container is also provided.

### CROSS-REFERENCE TO RELATED APPLICATIONS

This application claims the benefit of priority under 35 U.S.C. §119(e) to U.S. Provisional Patent Application Serial No. 60/419,165, filed Oct. 16, 2002, which is incorporated herein by reference.

### BACKGROUND OF THE INVENTION

1. Technical Field

The present invention relates to a method and system for the organization of samples. More specifically, the present invention relates to a system for organizing samples without directly labeling the samples.

2. Background Art

It is well known that containers including separate compartments can be used to store items. However, currently there is no system that organizes items such that an individual can locate a specific item in a specific compartment without having to open the container in which the item is located.

For example, there are polycarbonate containers that are currently available from VWR International Life Science. The containers include a numbered lid. The lid identifies numbered compartments within the container. Additionally, polycarbonate containers are also available wherein the container includes a colored bottom portion and a clear numbered lid. Similar containers are also available from Nalgene. None of the containers of the prior art enable an individual to locate an item within the storage container without having to open the container itself.

A fundamental problem with having to open the container to determine the contents of the container is that it wastes manpower. For example, if a company has twenty containers, an individual would have to open all twenty containers in order to locate a specific sample contained in one of the containers. It would therefore be beneficial to have an organizational system that would provide individuals with a clear, identifiable method or location wherein they can easily locate a specific item within the containers without having to manually search through each of a plurality of containers. It would also be useful to develop a storage box that includes writings on a bottom portion of the box that create a grid within the box for the identification of items within the box.

### SUMMARY OF THE INVENTION

According to the present invention, there is provided an organizational system marked grid including specific locations and a spreadsheet including designations relating to the locations on the marked grid, such that each of the designations includes details regarding items located in each of the locations. A method of organizing items by placing items in a marked grid and cataloging the location of the items in a corresponding spreadsheet is also provided. A method to organize goods in a container having a grid marked on a bottom portion of the container is also provided.

### DESCRIPTION OF THE DRAWINGS

Other advantages of the present invention are readily appreciated as the same becomes better understood by reference to the following detailed description when considered in connection with the accompanying drawings wherein:

FIG. 1 shows an example of a container of the present invention;

FIG. 2 shows an example of spreadsheets color-coordinated to each container;

FIG. 3 shows an example of spreadsheets, which appears on a computer monitor after scanning of a barcode pasted on the outer surface of bottom part of the container; and

FIG. 4 shows an example of a systemic organization of a sample located in the scientific container in a numbered rack space, which is located in an alphanumerically assigned freezer space.

### DETAILED DESCRIPTION OF THE INVENTION

The present invention provides a method and system, generally shown at 10 in the figures, for the organization of samples. The benefit of the present invention is that it does not require the direct labeling of the samples. This is beneficial because small samples can be difficult to label properly. Further, if the exterior label of a sample comes into contact with liquids, the label can become difficult to read or can peel off of the sample. The method and system of the present invention overcome these problems by removing the necessity for labels on the sample surface.

The “grid” of the present invention is any dividing device that creates separate compartments. The grid 16 creates compartments in a larger container. For example, the grid 16 can be located in a container 12 or alternatively, can be located in a freezer 30.

The container 12 of the present invention can be made of any material known to those of skill in the art. Examples of such materials include, but are not limited to, cardboard, fiberboard and plastic. The container 12 is formed using techniques known to those of skill in the art. Preferably, the container 12 includes four sides 14, 14′, 14″, 14′″ and a base 15. The container 12 can include a lid 20 for preventing material from entering the container 12. The lid 20 can include blank surfaces 22 thereon for advertisements or for the end user to write information. Preferably, the container 12 is colored or otherwise distinguishable from other similar shaped objects. For example, the container 12 can be any color or can include distinguishing indicia such as stripes, dots, etc. The containers can be used to store vials at room temperature and in a refrigerator, a freezer and a cryogenic (i.e., liquid nitrogen) storage tank.

The stability of the cardboard containers at ultra-low temperature was tested by storing the container at −80° C. in a liquid nitrogen tank for three weeks and comparing the stability of the containers stored in the tank with a new container. The containers stored at ultra-low temperature did not show any apparent damage in color, glue and strength of the cardboard.

The container can also be formed with only three sides, thus being triangularly shaped. The container can also be formed without a base, however the inclusion of a base is preferred. The container does not have to include a lid in order to function in the manner disclosed above.

Additionally, the container 12 can include advertisements on any exterior surface of the container 12. In this regard, the container serves as an advertisement tool. For example, the exterior surface of container 12 can include advertisements that relate to the use of the container. If the container 12 is used in a laboratory setting, the advertisements can pertain to laboratory equipment. If the container 12 is used in a closet, then the advertisements can pertain to clothing stores or accessories for the closet.

More specifically, the present invention provides a method and system 10 for organizing samples by providing a colored container containing therein a grid 18 or other similar device that creates divided space within the container 12. The grid 18 includes labels 16 on interior surfaces of the container 12 such that each space within the grid 18 can be located based upon the surface labels 16. For example, if two non-adjacent surfaces 14, 14″ of the container are labeled with the letter B and the other two non-adjacent surfaces 14′, 14′″ are labeled with a number 6, a space within the grid would be designed B6.

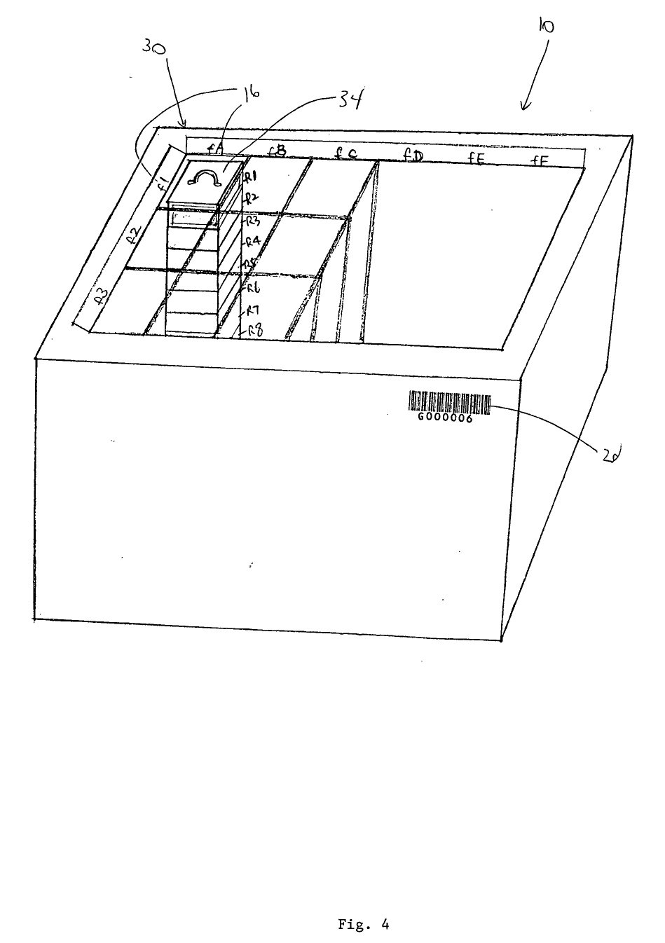

Designation of each cell 28 in the container 12 by this alphanumerical system can be used with additional organizational systems of a rack (R1, R2, etc.) and a freezer space (fAf1, fAf2, etc.) to assign each cell in a freezer. An example of the system 10 incorporated in a freezer 30 is shown in FIG. 4.

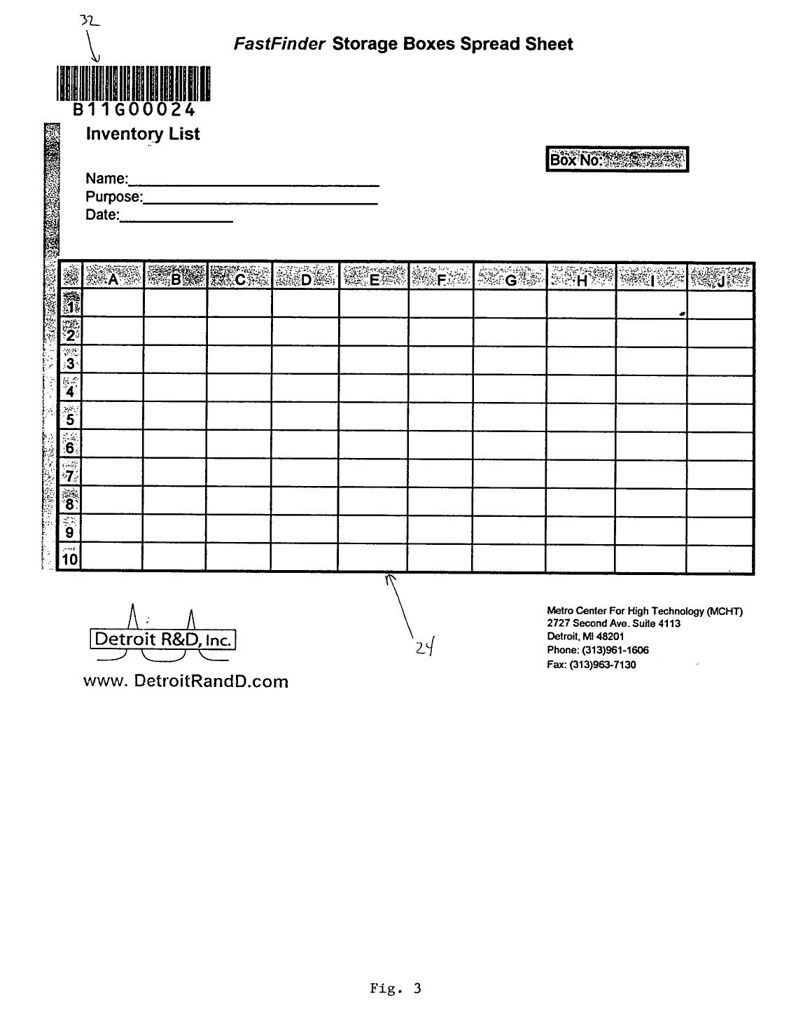

A spreadsheet 24 and container 12 of the present invention can also include a barcode 32. The barcode includes information regarding the container 12 and the contents of the container 12. The barcode 32 enables information to be obtained with regard to the container 12 based solely on the barcode 32. For example, each freezer can be barcoded to assign a freezer number, a rack number, locations in the rack and cell assignment of samples. Contents of the freezers were entered in a data bank equipped with a search engine. Any products stored in the several freezers can be searched to identify their locations. The barcode 32 can be pasted on the freezer 30, on an exterior surface of the container 12, on a rack 34 placed in the freezer 30, or even on individual items located in the container. Special software has been developed that combines a barcode system with a spreadsheet program (Microsoft Excel program). A typical spreadsheet 24 that includes the barcode is shown in FIG. 3.

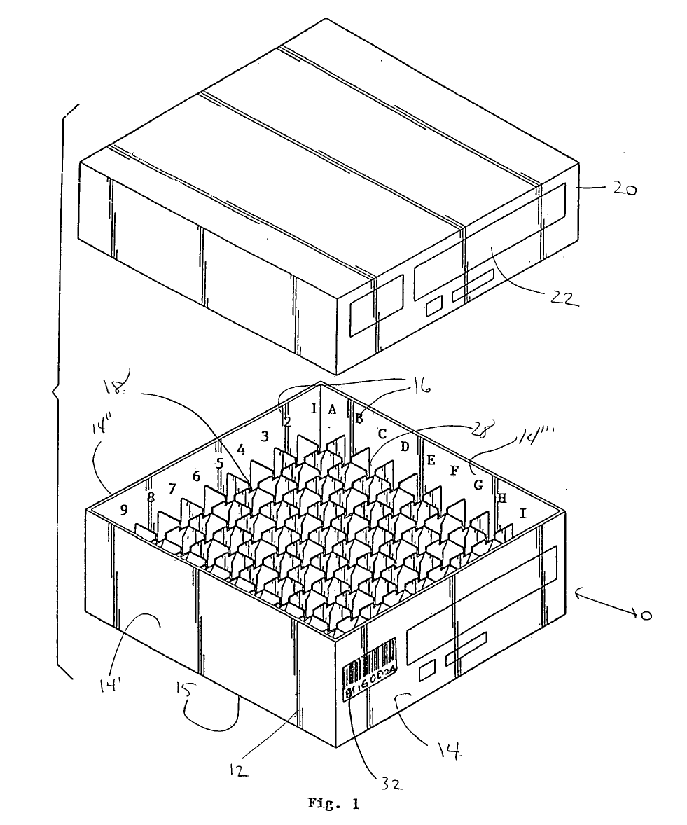

A spreadsheet 24 corresponds to each container 12, either on a sheet of paper or on a screen on a computer. The spreadsheet 24 is color coordinated with the color of the container 12. The sheet 24 includes blank spaces 26 corresponding to the spaces 28 within the container 12. Information regarding the contents of the sample can be placed in the empty spaces 26, such placement effectively labels the samples without the problems of the prior art detailed above. Each cell 28 produced by the grid 18 in the container 12 is assigned an identifier by its cell 28 within the grid 18 of the container 12 (FIG. 1).

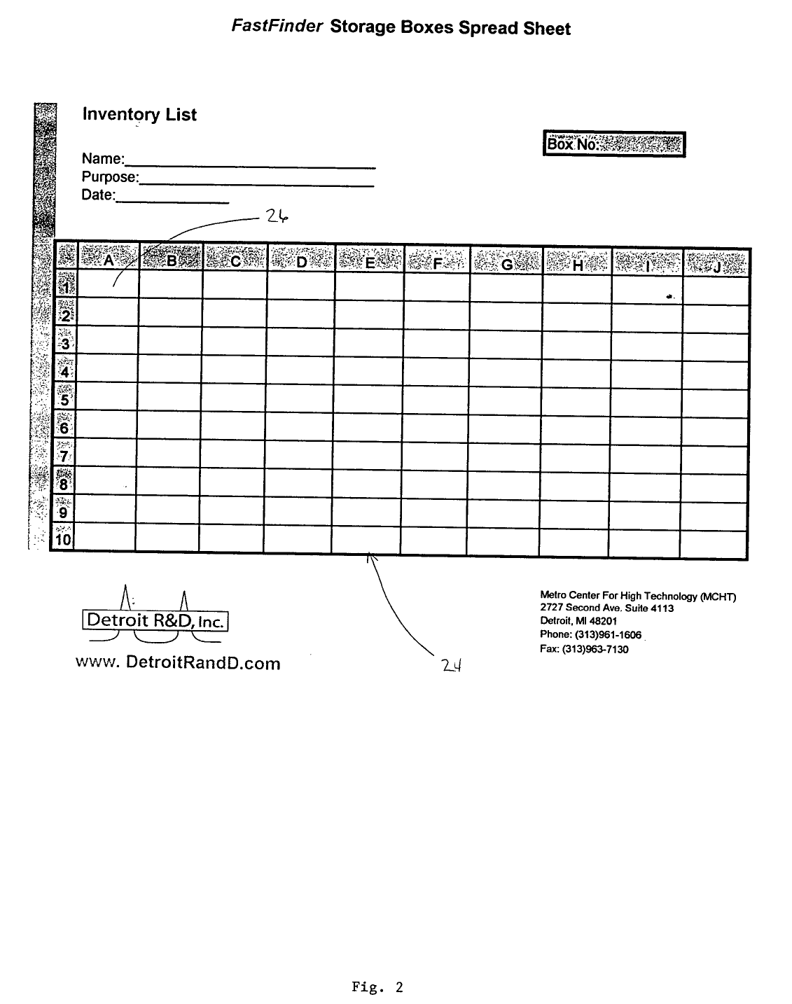

A spreadsheet 24 color coordinated with containers is shown in FIG. 2. After entering contents of each vial stored in a container in the proper space 26, the spreadsheet 24 is kept as a file. When looking for a previously stored vial, entry of the vial in the spreadsheet 24 is searched and color of the container and location of the cell in the container is identified. Knowing in advance the location of the vial in a refrigerator or a freezer saves effort of the user and minimizes loss of energy used to keep the a refrigerator and a freezer at cold temperature. Moreover, alphanumerically designated freezer space makes location of a sample in the alphanumerical container easier.

The spreadsheet 24 can be a computer-generated file with entries of content in a container 12. The color-coordinated spreadsheets 24 shown in FIG. 2 were prepared using the Microsoft Excel program (Microsoft, Inc.). An additional color-coordinated spreadsheet was prepared using the Microsoft Access program (Microsoft, Inc.) and a product description spreadsheet was produced and used for further description of the content in the vial.

The spreadsheets 24 of the present invention can be used to create a database of information such that the database can be searched in order to locate a specific item. The searching can be accomplished manually or via a computer program. For example, the spreadsheets can be searched using a search engine, using key words or via other similar methods of searching for information within a database.

A system for organizing samples without directly labeling the samples is disclosed. According to the present invention, goods in a storage container 12 are systematically organized using spreadsheets 24, which were produced manually or by a computer program with or without a barcode 32 system. With numbering and alphanumerical systems of racks 34 and freezers 30, this storage container 12 identifies a vial placed in the container 12. This can be achieved even without opening freezers. The storage containers 12 with various colors contain a grid 18 and each cell location 28 is assigned by alphanumerical writings 16 written inside the container 12. Contents in the container 12 are identified using a spreadsheet 24 accompanying the container 12. The method enables individuals to identify contents in the container 12 using computer files obtained by spreadsheet programs. The contents in the container 12 are also identified by a barcode 32 on the surface of the container 12 using a computer program that brings on the computer monitor exactly the same 2-dimensional space as in the alphanumerical container 12.

The methods used with and the utility of the present invention can be shown by the following non-limiting examples and accompanying figures. The above discussion provides a factual basis for the method and system of the present invention to save effort of a personnel and energy wasted by prolonged search in a refrigerator or freezer.

### EXAMPLES

### Example 1

Yellow containers were assigned to a senior research assistant who works for an immunoassay-related NIH grant. Blue containers were assigned to a research assistant who works for a COX-2-related NIH grant. The container color assigned to each grant corresponds to the color of a bank check used for each grant account set up at our company. Each container was barcoded with a unique identification code using the FastFinder barcode software, which matched the container color with the spreadsheet color of the container, e.g., B11G00024 shown in FIG. 2 is for Cat. #B11, green colored container, and container #24.

This practice efficiently separated containers stored in a refrigerator or a freezer according to projects carried out at our company. After scanning containers, each person entered contents of their containers and location of the containers (e.g., freezer number, rack number, location in the rack and cell assignment) in a color-coordinated spread sheet files and the product description spreadsheet in her/his computer.

### Example 2

Hybridomas were produced against 14,15- or 11,12-DHET conjugated KLH and kept in liquid nitrogen tanks. Red containers were assigned for hybridomas produced against 14,15-DHET and yellow containers were for hybridomas against 11,12-DHET. A color-coordinated spreadsheet was produced for each container and location of the container in the tanks was entered in the spreadsheet. Each tank was barcoded to assign a tank number, a rack number, location in the rack and cell assignment of samples.

### Example 3

Various products can be kept in freezers located at different places. Red containers were assigned for antibodies against cytochromes P450, yellow containers for antibodies against phase 11 drug-metabolizing enzymes including glutathione S-transferases and microsomal epoxide hydrolase, green containers for rat liver microsomes, taupe containers for rat kidney microsomes, and blue containers is for products related to a hypertension ELISA kit.

Each freezer was barcoded to assign a freezer number, a rack number, locations in the rack and cell assignment of samples. Contents of the freezers were entered in a data bank equipped with a search engine. Any products stored in the several freezers can be searched to identify their locations.

The barcode software was prepared using Wasp Fontware Pro+w/Add-inns for Word, Excell, Access, Crystal (Wasp Bar Code Technologies, Plano, TX) which were installed into the Microsoft Excell program according to the manufacturer's instruction. Specific parameters of the listed programs were chosen to create the program used for the present invention. The parameters were as follows: barcode symbology, code 3 of 9 full ASCII; point size, 24; resolution, medium; caption, below barcode; and digit, checked. A 2 dimensional spreadsheet was opened. A cell in the spreadsheet was highlighted by clicking a cell located at the proper position and an alphanumerical code assigned for the spreadsheet was input. A barcode with the alphanumerical code appeared in the cell.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

### REFERENCES

1. VWR International Life Science Catalog 2002-2003, p. 743.

2. VWR Scientific products Catalog 2000-2001, R1333.

3. Fisher Scientific Catalog 2002-2003, p. 1236.

4. VWR International Life Science Catalog 2002-2003, p. 256.

5. VWR International Life Science Catalog 2002-2003, p. 256.

6. VWR International Life Science Catalog 2002-2003, p. 256.

7. VWR International Life Science Catalog 2002-2003, p. 257.

What is claimed is:

1. An organizational system comprising:
a marked grid including specific locations and
a spreadsheet including designations relating to said locations on said marked grid, such that each of said designations includes details regarding items located in each of said locations and said spreadsheet is at least a two-dimensional.

2. The system according to claim 1, wherein said grid includes a color indentifier.

3. The system according to claim 2, wherein said spreadsheet includes a color indentifier matching said grid color indentifier.

4. The system according to claim 1, wherein said spreadsheet is identical to said marked grid and is printed on a piece of paper.

5. The system according to claim 1, wherein said spreadsheet is identical to said marked grid and is electronic.

6. The system according to claim 1, wherein said grid is marked on a bottom portion a container.

7. The system according to claim 6, wherein said container is made of a material selected from the group consisting essentially of cardboard and fiberboard.

8. The system according to claim 6, wherein said marked grid includes alphanumeric marking.

9. The system according to claim 1, wherein said grid is located in a freezer.

10. The system according to claim 1, wherein said grid is located in a rack.

11. The system according to claim 1, wherein said grid further includes a barcode placed on an exterior surface of said grid.

12. The system according to claim 11, wherein said spreadsheet further includes a barcode identical to said barcode on said grid.

13. The system according to claim 12, wherein said barcode system is produced by said two-dimensional spreadsheet.

14. A method of organizing items by:
placing items in a marked grid and
cataloging the location of the items in a corresponding spreadsheet.

15. The method according to claim 14, further including determining the location of items within the grid by locating the item within the spreadsheet.

16. The method according to claim 15, wherein said locating step includes searching the spreadsheet for the items.

17. The method according to claim 16, wherein said searching step includes electronically searching the spreadsheet.

18. The method according to claim 17, wherein said electronically searching step includes searching using a system selected from the group consisting of key word searching, database searching, and search engine searching.

19. An advertising tool comprising an advertisement placed on an organizational system comprising:
a marked grid including specific locations and
a spreadsheet including designations relating to said locations on said marked grid, such that each of said designations includes details regarding items located in each of said locations and said spreadsheet is at least a two-dimensional.

20. An organizational system comprising:
a cardboard container including a marked grid on a bottom portion of said container, said grid for designating specific locations within said container and
a two-dimensional spreadsheet including designations relating to said locations on said marked grid, such that each of said designations includes details regarding items located in each of said locations.

21. Barcode software comprising barcode software combined with word processing software.

22. The software according to claim 21, wherein said barcode software is Wasp Fontware Pro.

23. The software according to claim 21, wherein said word processing software is selected from the group consisting essentially of Word, Excell, Access, and Crystal.

24. The software according to claim 21, wherein said software includes specific parameters.

25. The software according to claim 24, wherein said parameters are selected from the group consisting essentially of barcode symbology, point size, resolution, caption, and digit.
